(19) United States
(12) Patent Application Publication
(10) Pub. No.: US 2011/0247267 A1
(43) Pub. Date: Oct. 13, 2011

(54) Mountable Planter Box

(76) Inventor: David E. Lutzke, Sheboygan, WI (US)

(21) Appl. No.: 12/757,572

(22) Filed: Apr. 9, 2010

(51) Int. Cl. A01G 9/02

(52) U.S. Cl. 47/65.7; 47/66.1

(57) ABSTRACT

A planter box assembly has a sheet metal frame with two opposed end walls connected by opposed front and back walls. The frame has a bottom opening and an upper peripheral rim. A molded plastic insert has a bottom wall with a plurality of upwardly extending side walls. The insert has a cavity which receives soil and plants. A peripheral flange extends outwardly from the insert side walls over the frame rim, allowing the plastic insert to be supported on the frame. Mounting holes in the frame front and back walls allow the planter box assembly to be mounted to a board or bracket which extends from a vertical post.

### CROSS REFERENCES TO RELATED APPLICATIONS

Not applicable.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to planter boxes in general, and more particularly to mountable planter boxes.

Although flowers and other outdoors cultivated plants are usually disposed directly in the ground, for decorative purposes or for more ready access, such plants may be elevated by being received within planter boxes which are mounted to some vertical structure. The conventional planter box has side walls which extend upwardly from a bottom, and which receive the planting soil directly, or within an optional box-like insert.

In my U.S. Pat. Nos. 7,497,368 and 7,185,803, the disclosures of which are incorporated by reference herein, I disclosed an economical and effective bracket for mounting elements including mail boxes to vertical posts.

What is needed is a planter box arrangement which is convenient and economical, and which allows plantings to be readily mounted in desired positions to support structures.

### SUMMARY OF THE INVENTION

The planter box assembly of the present invention has a sheet metal frame with two opposed end walls connected by opposed front and back walls. The frame has a bottom opening and an upper peripheral rim. A molded plastic insert has a bottom wall with a plurality of upwardly extending side walls. The insert has a cavity which receives soil and plants. A peripheral flange extends outwardly from the insert side walls over the frame rim, allowing the plastic insert to be supported on the frame. Mounting holes in the frame front and back walls allow the planter box assembly to be mounted by a bracket to a vertical post, similar to the way a mailbox is mounted. The walls of the frame are tapered, to allow multiple frames to be nested one within the other for shipping and display at point of purchase. Inwardly projecting ribs on opposed front and back walls stiffen the frame and also serve as denesting structures.

It is an object of the present invention to provide a planter box arrangement which provides a stiff supporting structure for a planter insert which minimizes standing water on horizontal metal surfaces.

It is another object of the present invention to provide a lightweight support frame for a planter box insert which is compactly nestable.

It is a further object of the present invention to provide a planter box arrangement which provides for secure mounting to a vertical structure.

It is yet another object of the present invention to provide a mountable planter box so arranged that the support frame contains no bottom portion, thereby reducing material and weight.

Further objects, features and advantages of the invention will be apparent from the following detailed description when taken in conjunction with the accompanying drawings.

### BRIEF DESCRIPTION OF THE DRAWINGS

FIG. 1 is an exploded isometric view of the planter box arrangement of the present invention having an insert received within a frame which is mounted to a bracket attached to a post. A portion of one wall of the frame is broken away to better show the interior.

FIG. 2 is an enlarged fragmentary cross-sectional view of the arrangement of FIG. 1.

FIG. 3 is a fragmentary isometric view of an alternative embodiment planter box arrangement of the present invention, in which the frame is mounted to a board which is connected by screws to the bracket.

FIG. 4 is an exploded isometric view of an alternative embodiment planter box arrangement of the present invention having an insert received within a frame having upper bent flanges, and which is mounted to a horizontal member attached to a post. A portion of one wall of the frame is broken away to better show the interior.

FIG. 5 is an enlarged fragmentary cross-sectional view of a planter box arrangement of the present invention having upper bent flanges and tapered side walls.

FIG. 6 is an enlarged fragmentary cross-sectional view of an alternative embodiment planter box arrangement of this invention in which the frame terminates in a vertical edge.

FIG. 7 is an enlarged fragmentary cross-sectional view of an alternative embodiment planter box arrangement of this invention in which the frame terminates in a hemmed edge.

### DESCRIPTION OF THE PREFERRED EMBODIMENTS

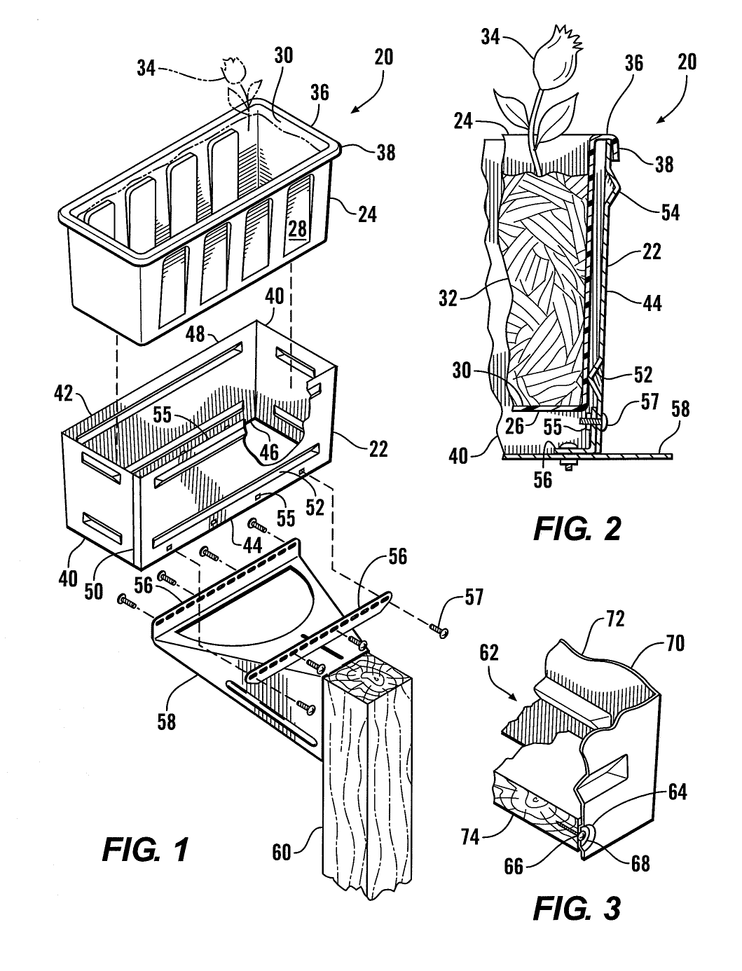

Referring more particularly to FIGS. 1-7, wherein like numbers refer to similar parts, a planter box assembly 20 is shown in FIGS. 1 and 2 comprised of a sheet metal frame 22 which receives a molded plastic insert 24. The insert 24 may be a conventional molded plastic flower box liner such as the POLLY-PRO liners manufactured by Novelty Mfg. Co. of Lancaster, Pa. The insert 24 has a bottom wall 26 with a plurality of upwardly extending side walls 28. The insert 24 has a soil cavity 30 defined between the side walls 28 and the bottom wall 26, which receives soil 32, as shown in FIG. 2, in which plants 34 are grown. The insert 24 has an outwardly extending peripheral flange 36 which extends from the upper margin of the side walls 28 and which is terminated in a downwardly extending skirt 38.

The frame 22 has two opposed end walls 40 which are connected by an opposed front wall 42 and a back wall 44. A bottom opening 46 is defined between and beneath the end walls 40 and the front and back walls 42, 44. The upper margin of the frame 22 end walls and front and back walls defines an upper peripheral rim 48. The insert 24 flange 36 extends over and engages the frame peripheral rim 48, to thereby support the insert on the frame. The frame 22 is preferably assembled from two like sheet metal parts, each forming one of the end walls and one of the front or back walls. Each part has a folded tab 50 which is connected such as by welding or riveting to the other part. It will be noted that, with no bottom, the frame provides less opportunity for standing water to remain on the metal surfaces and promote corrosion.

The frame 22 is preferably formed with converging walls, such that a plurality of frames can be shipped and displayed in stacked and nested condition. Thus the frame front and back walls converge towards each other as they extend downwardly, and the end walls converge towards each other as they extend downwardly. As shown in FIG. 2, each wall of the frame 22 may be formed with two vertically spaced horizontal ribs 52, 54. The lower ribs 52 protrude inwardly, and serve as denesting structures when multiple frames are stacked. The upper ribs 54 protrude outwardly.

As shown in FIG. 1, the frame 22 front wall 42 and back wall 44, are formed each with a row of punched-out mounting holes 55. The mounting holes 55 may be openings through which a metal screw 57 may extend to fasten the walls of the frame 22 to angle brackets 56 extending from a sheet metal main bracket 58 which is mounted to a vertical post 60. The frame mounting holes in the front and back walls thus allow the frame 22 to be conveniently mounted in a fashion very similar to the way a conventional mailbox is mounted to a roadside post. The mounting bracket assembly may be similar to the one shown in my U.S. Pat. No. 7,497,368. Multiple mounting bracket assemblies can be mounted to a single post, to allow multiple planter boxes to be affixed to a single post. The inserts 24 are not fixed to the frames 22, and thus can be readily removed to permit the plantings therein to be tended at a location remote from the frame, or to switch out inserts for ones with different plantings.

A portion of an alternative embodiment planter box assembly 62 is shown in FIG. 3. The assembly 62 has depressions 64 surrounding each mounting hole 66 which allow a vertical region 68 of the back wall 70 of the frame 72 to engage against the vertical edge of a wooden board 74. The wooden board 74 may then be nailed or screwed in place on a conventional vertical post. It should be noted that a gap is preferably left between the board 74 and the end walls to allow water drainage.

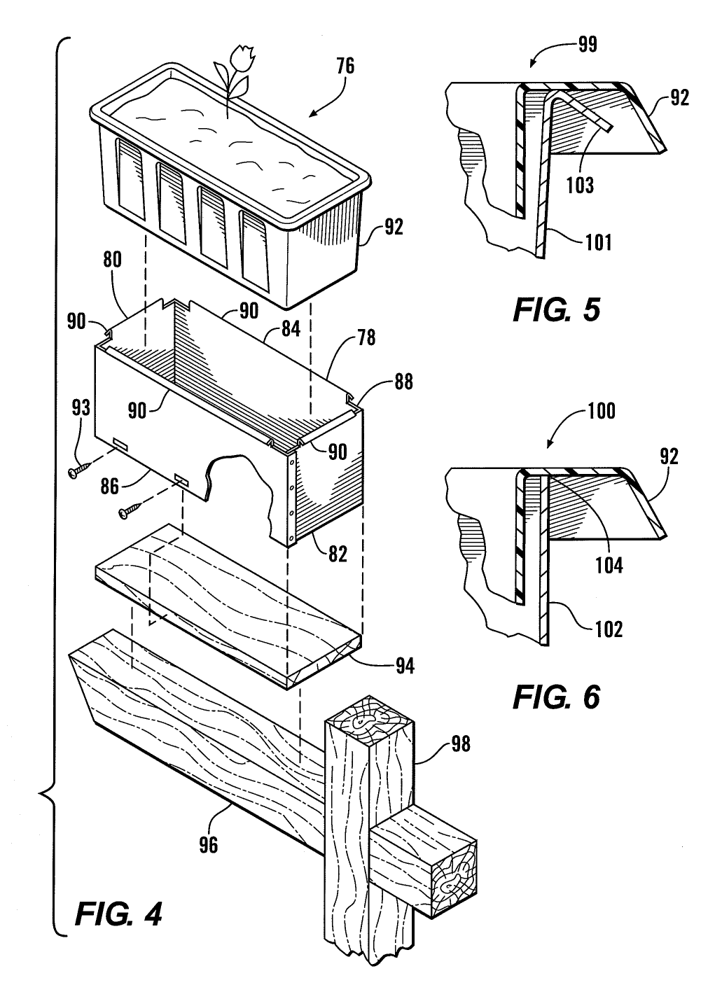

An alternative embodiment planter box assembly 76 is shown in FIG. 4. This arrangement has a frame 78 having a first end wall 80 spaced opposite a second end wall 82 and connected to the second end wall by a back wall 84 and a front wall 86. The walls of the frame 78 may be substantially vertical as shown in FIG. 4, or they may be inclined as in the arrangement of FIG. 1 to permit stacked frames to be nested.

The frame 78 walls define an upper peripheral rim 88, and each wall 80, 82, 84, 86 is topped by a narrow outwardly extending flange 90. The flanges 90 contribute to the stiffness of the frame. The flanges 90 may extend substantially outwardly, or, as shown in FIGS. 4 and 5, may also be angled downwardly, and it is at the juncture between the flanges and the peripheral rim 88 that the molded plastic insert 92 is engaged. It should be noted that the structures of inserts 92 may vary such that a flange or some other outwardly projecting portion of the insert is engaged.

The frame 78 is connected by fasteners 93 such as screws to an underlying board 94 of wood, plastic, or other appropriate material, which is attached by fasteners, not shown, to a projecting horizontal member 96 which extends from a wooden post 98. The board could alternatively be a plastic universal mailbox mounting plate, such as prior art part #PLMB, manufactured by Solar Group Inc., Taylorsville, Miss.

In FIG. 5, an alternative embodiment 99 has vertical side walls 101 from which the flanges 103 extend.

In another alternative embodiment arrangement 100, shown in FIG. 6, the frame 102 has vertical walls which are terminated by a peripheral edge 104 which has no flanges.

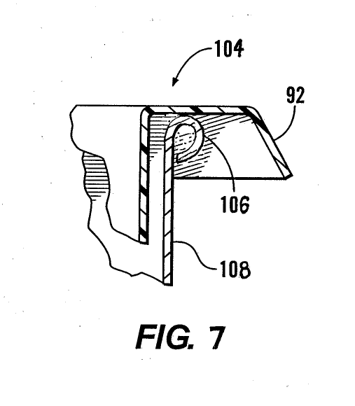

In another alternative embodiment 104, shown in FIG. 7, the frame 106 has vertical walls which have a peripheral edge 108 in which the metal is turned or hemmed.

It should be noted that the oblong slots 55 illustrated in the arrangement of FIG. 1 permit the frame to be assembled from two identical parts. The fasteners which extend through the slots can thus pass through the slots at different locations and still remain directly opposed to one another, even if the wall thickness of the sheet metal of which the identical parts is formed causes the slots themselves to not be exactly aligned.

It should be noted that although the preferred embodiment of the frame is fabricated of sheet metal, it may also be formed of other suitable material, for example it may be molded of plastic.

It is understood that the invention is not limited to the particular construction and arrangement of parts herein illustrated and described, but embraces all such modified forms thereof as come within the scope of the following claims.

1. A planter box assembly comprising:
a frame having two opposed end walls connected by opposed front and back walls, a bottom opening being defined between and beneath the end walls and the front and back walls, wherein an upper peripheral rim is defined by portions of the end walls and the front and back walls;
an insert having a bottom wall with a plurality of upwardly extending side walls, the insert defining a soil cavity therein;
portions of the insert which extend outwardly from the side walls and which extend over and engage the frame peripheral rim, to thereby support the insert on the frame; and
wherein at least one of the frame walls has portions which define at least one mounting hole through which a fastener may extend to fix the frame to a support.

2. The planter box assembly of claim 1 wherein the frame front and back walls converge towards each other as they extend downwardly, and the end walls converge towards each other as they extend downwardly such that the frame is tapered, to permit multiple like frames to be nested one within the other.

3. The planter box assembly of claim 1 further comprising at least one rib formed in at least two of the frame walls.

4. The planter box assembly of claim 3 wherein two ribs are formed in each of the two opposed end walls and the opposed front and back walls, and wherein one of said two ribs protrudes outwardly from the frame, and one of the said two ribs protrudes towards the interior of the frame.

5. The planter box assembly of claim 1 further comprising a bracket which underlies the frame, the bracket having upwardly extending portions which extend alongside of the front and back walls of the frame, and which are fastened to the frame.

6. The planter box assembly of claim 1 further comprising a board which is received within the frame bottom opening, and which is fastened to the frame front and back wall.

7. The planter box assembly of claim 1 wherein the frame peripheral rim is hemmed.

8. The planter box assembly of claim 1 wherein the frame is formed of sheet metal.

9. The planter box assembly of claim 1 wherein the frame is molded of plastic.

10. A sheet metal frame for assembly with an insert having a bottom wall with a plurality of upwardly extending side walls, defining a soil cavity therein to form a planter box assembly, the frame comprising:
a first end wall;
a second end wall opposed to and facing the first end wall
a front wall extending between the first end wall and the second end wall;
a back wall extending between the first end wall and the second end wall, wherein a bottom opening is defined between and beneath the end walls and the front and back walls, and wherein an upper peripheral rim is defined by portions of the end walls and the front and back walls, the peripheral rim being positioned to engage a peripheral portion extending outwardly from an insert side wall to thereby support the insert on the frame; and
portions of the frame front wall and the frame back wall which define a plurality of mounting holes;
wherein the frame front and back walls converge towards each other as they extend downwardly, and the end walls converge towards each other as they extend downwardly such that the frame is tapered, to permit multiple like frames to be nested one within the other, wherein portions of the frame front wall and the frame back wall define inwardly protruding denesting ribs.

11. The planter box assembly of claim 10 further comprising at least one rib formed in each of the frame walls.

12. The planter box assembly of claim 11 wherein two ribs are formed in each of the two opposed end walls and the opposed front and back walls, and wherein one of said two ribs protrudes outwardly from the frame.

13. A sheet metal frame for assembly with an insert having a bottom wall with a plurality of upwardly extending side walls, defining a soil cavity therein to form a planter box assembly, the frame comprising:
a first end wall;
a second end wall opposed to and facing the first end wall
a front wall extending between the first end wall and the second end wall;
a back wall extending between the first end wall and the second end wall, wherein a bottom opening is defined between and beneath the end walls and the front and back walls, and wherein an upper peripheral rim is defined by portions of the end walls and the front and back walls, the peripheral rim being positioned to engage a peripheral portion extending outwardly from an insert side wall to thereby support the insert on the frame; and
portions of the frame front wall and the frame back wall which define a plurality of mounting holes; and
flanges which extend outwardly from the frame front wall, back wall, and end walls.

14. The sheet metal frame of claim 13 wherein the frame front and back walls converge towards each other as they extend downwardly, and the end walls converge towards each other as they extend downwardly such that the frame is tapered, to permit multiple like frames to be nested one within the other, wherein portions of the frame front wall and the frame back wall define inwardly protruding denesting ribs.

15. The planter box assembly of claim 13 further comprising at least one rib formed in each of the frame walls.

16. The planter box assembly of claim 13 wherein two ribs are formed in each of the two opposed end walls and the opposed front and back walls, and wherein one of said two ribs protrudes outwardly from the frame.
